(19) United States
(12) Patent Application Publication
(10) Pub. No.: US 2025/0160245 A1
(43) Pub. Date: May 22, 2025

(54) SENSITIVE FLOAT MECHANISM FOR LAWN MOWER LIFT SYSTEM

(71) Applicant: Textron Inc., Providence, RI (US)

(72) Inventor: Kyle Douglas Olason, Thief River Falls, MN (US)

(73) Assignee: Textron Inc., Providence, RI (US)

(21) Appl. No.: 18/514,683

(22) Filed: Nov. 20, 2023

(51) Int. Cl. A01D 34/00; A01D 34/54; A01D 101/00; G06T 7/70

(52) U.S. Cl. CPC A01D 34/006; A01D 34/54; G06T 7/70; A01D 2101/00; G06T 2207/30188; G06T 2207/30252

(57) ABSTRACT

One embodiment is a control system for a vehicle cutting system, the vehicle cutting system comprising a cutting unit connected to a lift arm of a lift system via a yoke, the lift system comprising a lift actuator for lifting and lowering the lift arm, the cutting unit and the yoke. The control system comprising a sensor for sensing a displacement of the yoke from a nominal position relative to a central support of the yoke and for generating a displacement signal indicative of the sensed displacement; and a controller for processing the displacement signal and adjusting a position of the lift actuator based on the processing.

### TECHNICAL FIELD

This disclosure relates generally to the field of riding lawn mowers and other vehicles and, more particularly, though not exclusively, to a sensitive float mechanism for lift systems of such riding lawn mowers and other vehicles.

### BACKGROUND

A riding lawn mower, especially a commercial riding lawn mower, may include lift systems for lifting and lowering cutting units of the lawn mower. Such lift systems typically include lift actuators, which in some embodiments may comprise electric linear actuators.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIGS. 1A-1E are various views of an example lawn mower in which embodiments described herein may be implemented;

FIGS. 2A-2C are perspective views of a lift system of the lawn mower illustrated in FIGS. 1A-1E according to features of embodiments described;

FIG. 3 is a rear perspective view of a cutting unit of the lawn mower illustrated in FIGS. 1A-1E according to features of embodiments described herein;

FIG. 4 is a side cutaway view of the cutting unit of FIG. 3 according to features of embodiments described herein;

FIGS. 5A-5C are side plan views of the cutting unit of FIG. 3 according to features of embodiments described herein;

FIG. 6A is an example system block diagram of a control system of a lawn mower according to features of embodiments described herein;

FIG. 6B is an example system block diagram of a cutting system of the lawn mower control system of FIG. 6A according to features of embodiments described;

FIG. 7A is a flowchart illustrating example operations performed by a lawn mower control system of FIG. 6A according to features of embodiments described herein; and

FIG. 7B is a flowchart illustrating other example operations performed by a lawn mower control system of FIG. 6A according to features of embodiments described herein.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, “raised”, “lowered”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this specification, the terms “forward,” “aft,” “inboard,” and “outboard” may be used to describe relative relationship(s) between components and/or spatial orientation of aspect(s) of a component or components. The term “forward” may refer to a spatial direction that is closer to a front of a vehicle relative to another component or component aspect(s). The term “aft” may refer to a spatial direction that is closer to a rear of a vehicle relative to another component or component aspect(s). The term “inboard” may refer to a location of a component that is within the fuselage of a vehicle and/or a spatial direction that is closer to or along a centerline of the vehicle (wherein the centerline runs between the front and the rear of the vehicle) or other point of reference relative to another component or component aspect. The term “outboard” may refer to a location of a component that is outside the fuselage of a vehicle and/or a spatial direction that is farther from the centerline of the vehicle or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying figures.

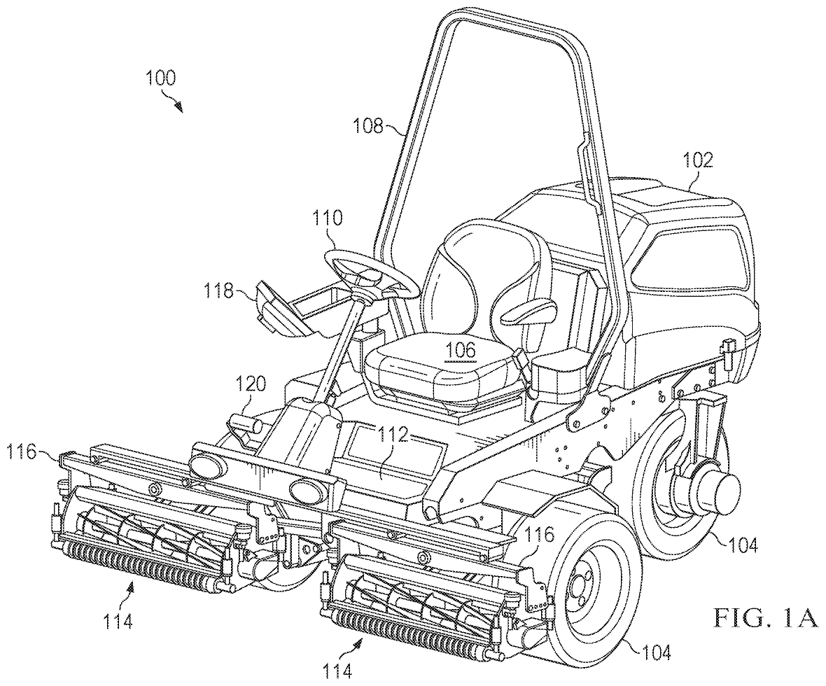

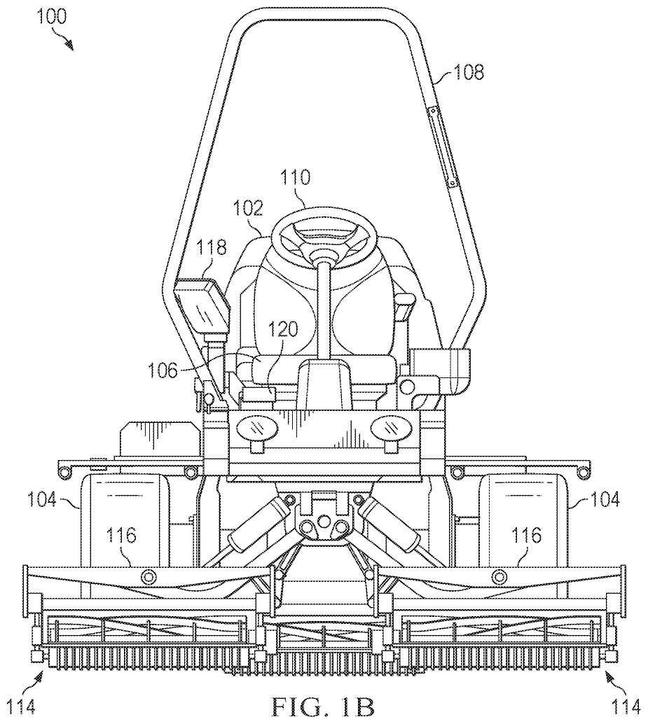

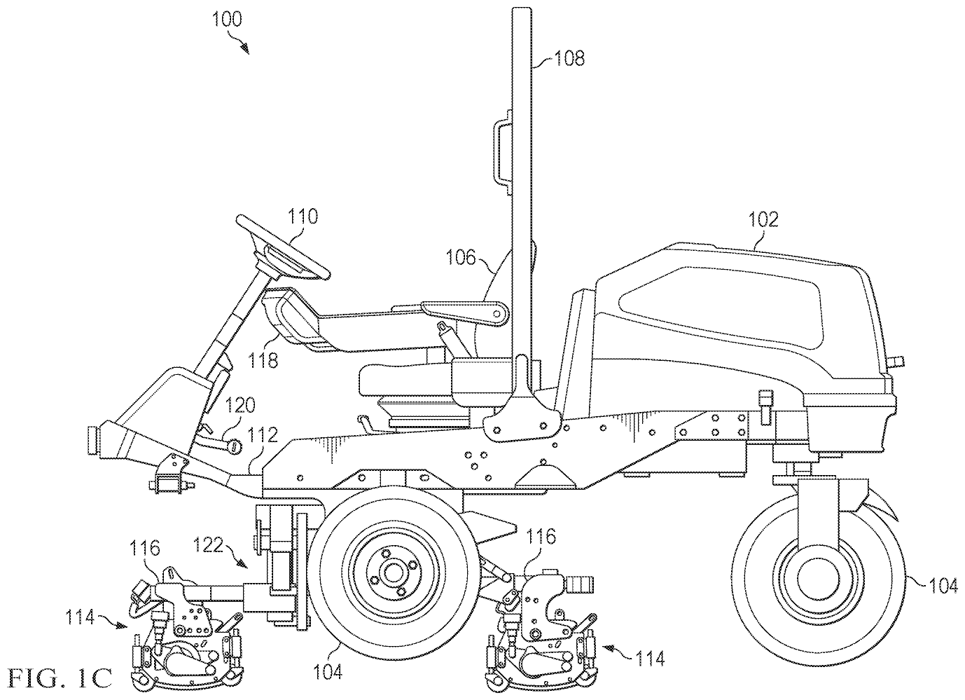

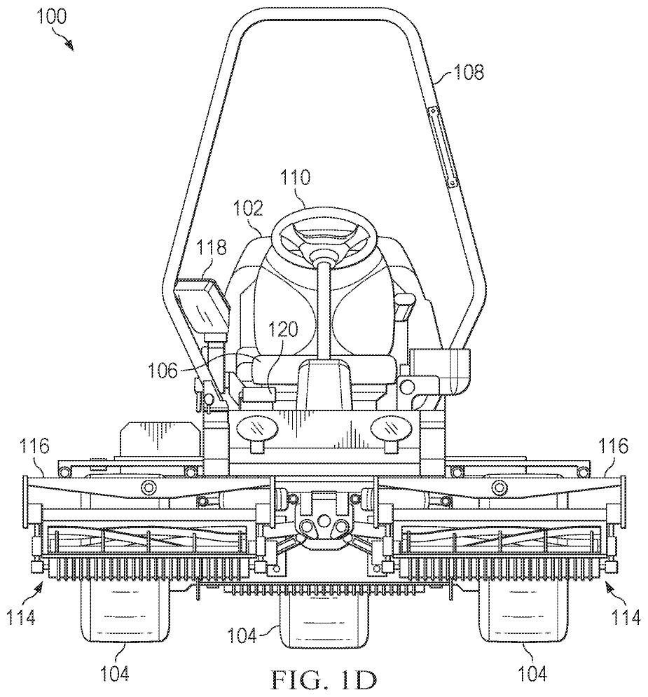

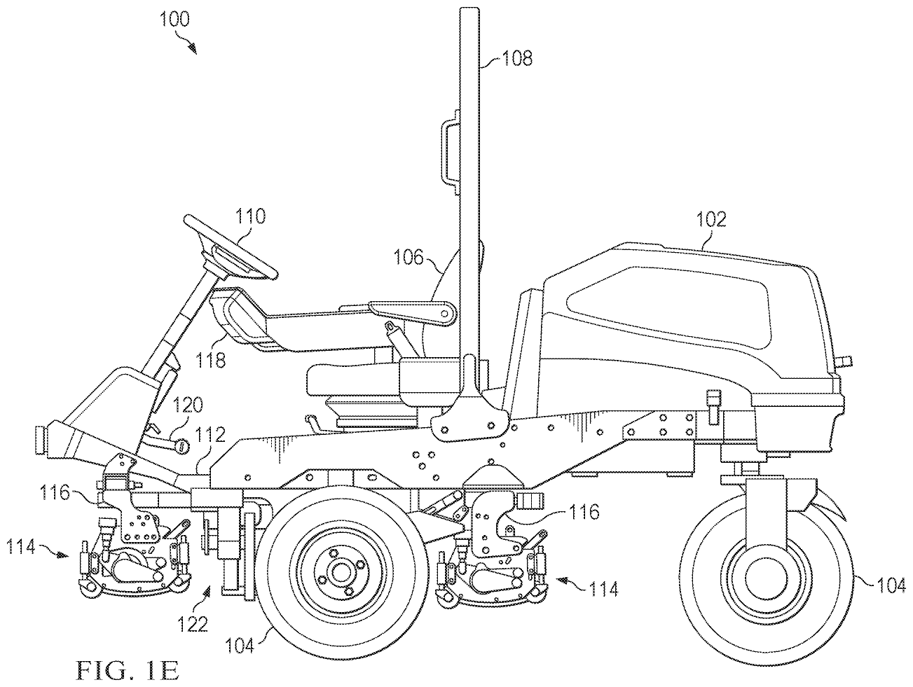

FIGS. 1A-1E illustrate various views of a vehicle comprising a lawn mower 100 in which embodiments described herein may be implemented. In particular, FIG. 1A illustrates a front perspective view of the mower 100, FIGS. 1B and 1D illustrate front plan views (particularly left side plan views) of the mower 100, and FIGS. 1C and 1E illustrate side plan views of the mower 100. As will be described in greater detail below, FIGS. 1B and 1C illustrate cutting units of the mower 100 in a lowered position, in which the mower 100 may be in a MOW mode, while FIGS. 1D and 1E illustrate cutting units of the mower 100 in a raised position, in which the mower 100 may be in a TRANSPORT or other non-MOW mode. It will be recognized that although particular embodiments are described herein with specific reference to lawn mowers, such as lawn mower 100, the embodiments may find application in a variety of other types of vehicles, such as golf carts, utility vehicles, and recreational vehicles, for example. As such, “lawn mower,” “mower” and “vehicle” may be used interchangeably herein.

In particular embodiments, lawn mower 100 may be used for mowing a golf course or other large area of grass or lawn. Lawn mower 100 may include an engine cover/hood 102, ground-engaging members, which in the illustrated embodiment are implemented as wheels 104 including tires installed thereon and/or associated therewith, a seat 106, a roll-over protection bar 108, a steering wheel 110, a footrest 112, and cutting units 114, which are connected to a lift system via yokes 116. Yokes 116 operate as pitch and roll devices that allow respective cutting units 114 to follow the terrain being transited by mower 100 independently of the other cutting units and allows the vehicle to optimize ground contact. In the illustrated embodiment, mower 100 includes three wheels 104, including two front wheels and one rear wheel; however, it will recognized that different wheel configurations, including different numbers and positions of wheels, may be provided. Additionally, in the illustrated embodiment, mower 100 includes three cutting units 114 with corresponding yokes 116; however, more or fewer cutting units/yokes may be provided.

As noted above, FIGS. 1B and 1C illustrate cutting units 114 in a lowered position (e.g., MOW mode), in which cutting units are active for mowing grass growing on a surface on which mower 100 is transiting. In contrast, FIGS. 1D and 1E illustrate cutting units 114 in a raised position (e.g., TRANSPORT or other non-MOW mode), appropriate for moving the mower 100 from one area to another without actively mowing. A control panel 118 is also provided for enabling an operator (e.g., seated in seat 106) to control various modes of operations of mower 100 in accordance with features of embodiments described herein. In particular embodiments, control panel 118 may include one or more of a display unit including a graphical user interface (GUI) and a switch panel including one or more physical switches and/or joysticks, for example. Display unit may include a touchscreen and may be used to convey information to and/or receive information from an operator of mower 100. A traction pedal 120 is provided and may be implemented as a foot pedal on an operator's platform, much like an accelerator pedal in an automobile. The pressure applied to the traction pedal by an operator's foot indicates the speed at which the operator intends the mower to operate. For example, when the traction pedal is fully depressed, the mower travels at 100% of its maximum speed.

As noted above, cutting units 114 are connected via yokes 116 to lift arm of a lift system 122 (best shown in FIG. 1C) for selectively lifting and lowering the cutting units. As will be described in greater detail below, lift system 122 includes actuators, which in particular embodiments, such as those in which the mower 100 is an electric vehicle (EV), are implemented as electric linear actuators. It will be recognized that in some embodiments, actuators may comprise rotary, as opposed to linear, actuators.

An electric linear actuator may include an integrated spring brake such that terrain-following behavior expected from a professional mower, such as mower 100, may be handled by incorporating slots into the mounting points between the lift system and the yoke of each cutting unit. In such configurations, the lift pin of each actuator engages the corresponding slot provided in the yoke, resulting in a slight delay in the lifting and lowering of the cutting unit due to the time required for the slack in the slot to be traveled by the lift pin. In alternative embodiments, the spring brake may be removed from the electric linear actuator such that the slot may be eliminated. Removal of the spring brake requires an external lock to be provided for retaining a cutting unit in a lifted position, such as during transport or storage, which is also undesirable.

In accordance with features of embodiments described herein, a sensitive float mechanism may include a sensing system integrated into or otherwise associated with each yoke, lift arm, and/or cutting unit of a mower, such as mower 100. In particular embodiments, the sensing system may be disposed on the lift arm between the connection point of the actuator and the yoke. In other embodiments, the sensing system may be disposed between the yoke and the cutting unit. In still other embodiments, the sensing system may be disposed between the front/rear roller and the frame of the cutting unit.

In particular embodiments, the sensing system may include a pivot point with a yoke sensor arm that allows for the cutting unit to oscillate up and down in small increments (e.g., 5 cm total). A sensor (e.g., a potentiometer) having a mechanical linkage to a fixed point and to the yoke sensor trailing arm would detect the oscillation as a change in value. The detected change in value may be fed into a closed loop to the actuator for use in adjusting extend/retract commands thereto. Additionally and/or alternatively, the detected change in value may be input to an MCU connected to a controller area network (CAN) bus, or CANBUS, of the mower 100, which may use the data comprising the change in value as an input to a predictive algorithm for forecasting how the other cutting units may be requested to change the position of the actuator. Additionally and/or alternatively, the data provided by all of the sensors may be used to generate an estimate of terrain the vehicle is traversing. In vehicles that have additional autonomy, the such information could be combined with image data generated by onboard image sensors, such as cameras and/or light detection and ranging (LIDAR) sensors, to construct a terrain map around the vehicle. Such a terrain map could be stored for future use by the mower or other mowers or vehicles. Additionally and/or alternatively, the terrain map could be used in predicting adjustments to be made to positions of actuators of a vehicle traversing the terrain.

In alternative embodiments, a strain gauged shaft could be used instead of or in addition to the sensor to sense oscillation from nominal. In such embodiments, the change in value of the strain gauge could be used to predict the need to change the state or position (i.e., extension) of the actuator. This information could also be fed into a closed loop or to the CANBUS as described above depending on integration requirements.

Embodiments described herein allow for faster reaction system that could utilize standard electric linear actuators with minimal to no modifications. By eliminating slots that add “slop”, the operator obtains more direct control to raise/lower function of cutting units. By retaining the spring brake, the need to incorporate an additional locking mechanism is avoided.

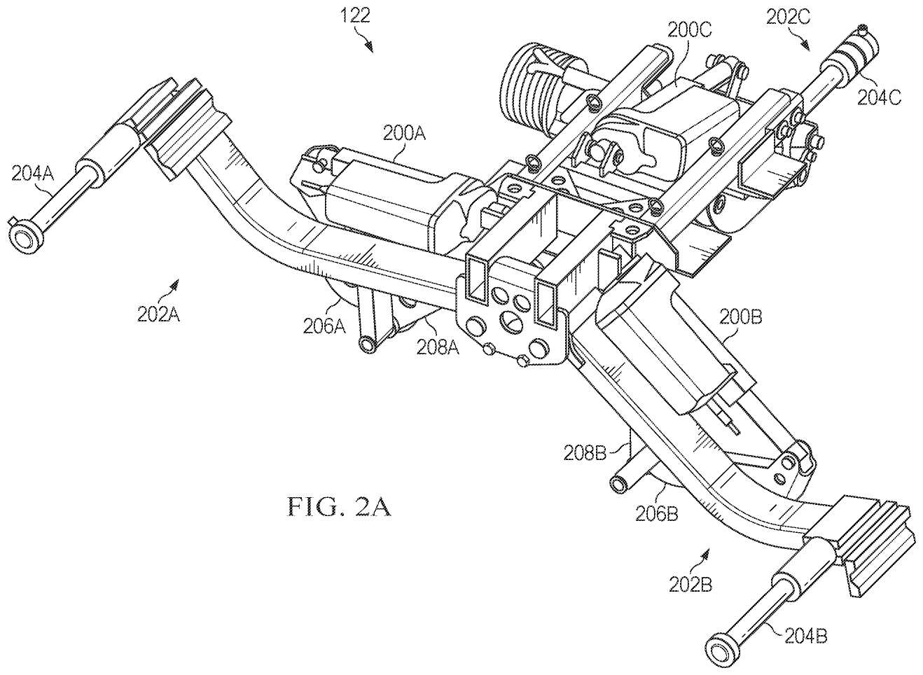

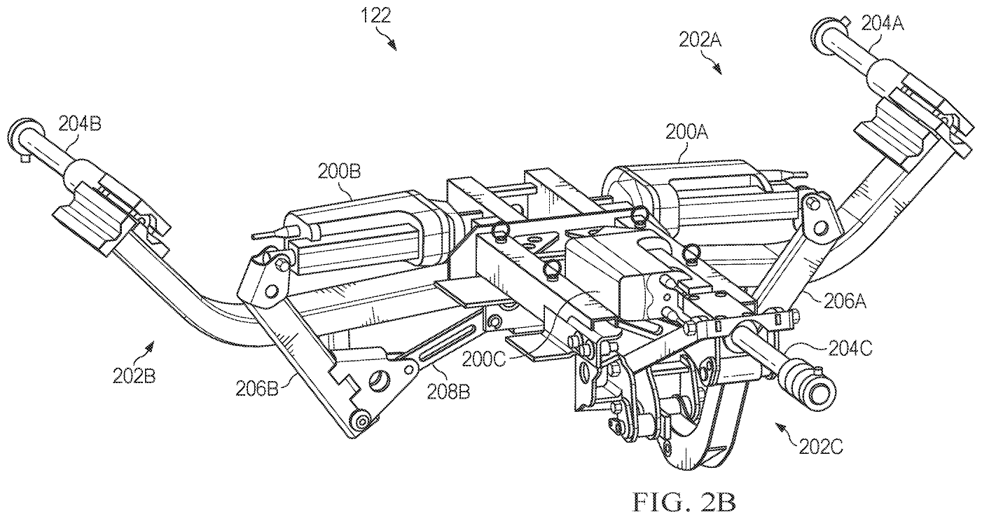

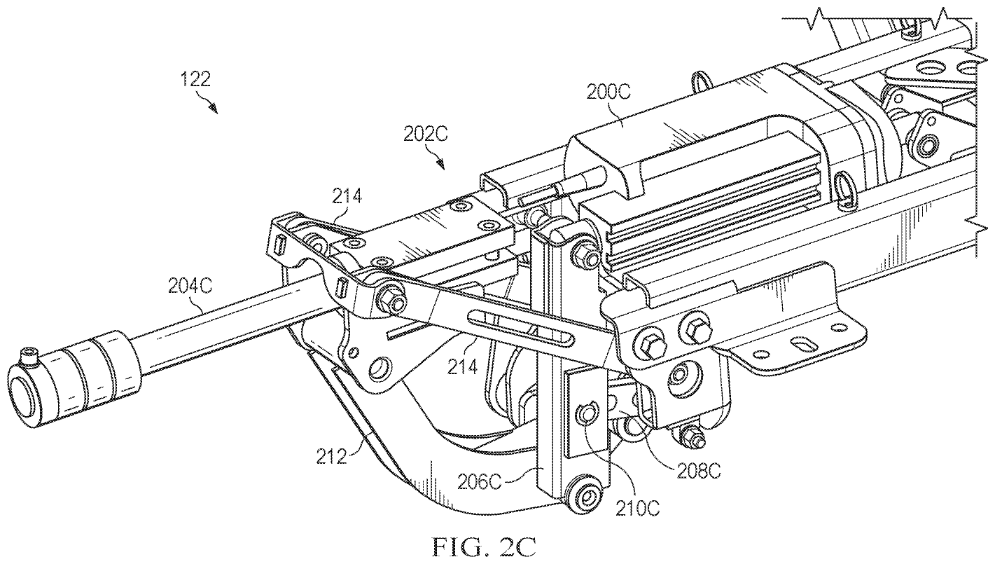

FIGS. 2A and 2B illustrate perspective views of lift system 122 from the front (FIG. 2A) and rear (FIG. 2B). As shown in FIGS. 2A and 2B, lift system 122 includes lift actuators 200A-200C, which in the illustrated embodiment comprise electric linear actuators, connected to respective lift arms 202A-202C. In the illustrated embodiment, lift arms 202A and 202B correspond to front left and right wheels of mower 100, respectively, and lift 202C corresponds to rear wheel of mower. Each lift arm 202A-202C is provided with a cutting unit mount 204A-204C, on which respective cutting units are mounted.

FIG. 2C illustrates a perspective view of lift arm 202C showing the arm in greater detail. As best shown in FIG. 2C, lift arm 202C may include a pivot link 206C and a floating link 208C. Pivot link 206C pivots around a point 210C, which is an axis connecting pivot link 206C ad floating link 208C. Lift arm 202C further includes a lower lift arm 212 and upper lift arms 214 connected to lower lift arm 212. Pivot axis through point 210C moves as lift system 122 move up and down, thereby providing actuator 200C its lowest variation in force across the lifting range. Pivot link 206C is connected via an axis to lower lift arm 212. Rotation of pivot link 206C about point 210C as the actuator 200C extends or retracts causes yoke pivot shaft 204C to raise or lower, respectively. Upper arms 214 and lower arm 212 are arranged in length and location to control the orientation or pitch of cutting unit mount 204C as the lift system 122 raises and lowers to keep the cutting unit 114 in optimal orientation relative to the ground. In the illustrated embodiment, it maintains the shaft of cutting unit mount 204C horizontal through motion due to arms 214 and 212 being equal in length. Floating link 208C is rotatably coupled to the structure, which allows refinement of the ratio of cutting unit motion to actuator motion.

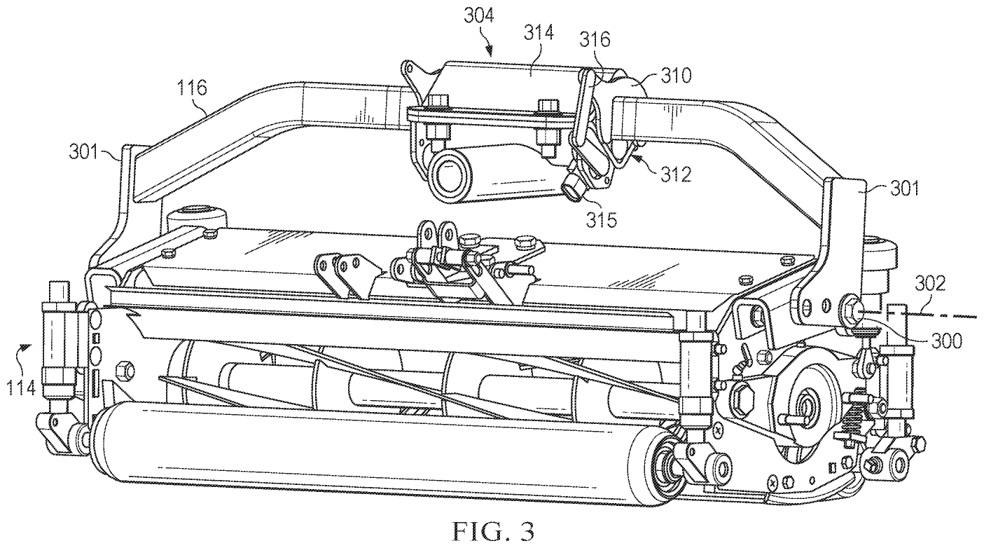

FIG. 3 illustrates the connection mechanism between cutting unit 114 and yoke 116 in greater detail. As shown in FIG. 3, yoke 116 is connected to cutting unit 114 via coaxial bolts 300 (only one of which is visible in FIG. 3) through endplates 302 disposed on opposite ends of yoke 116. This connection forms a pitch axis 302 about which cutting unit 114 may rotate relative to yoke 116 to enable cutting unit to follow terrain up and down separate from mower. As illustrated in FIG. 3, a sensitive float mechanism 304 comprising features of embodiments described herein is provided proximate the center of yoke 116 and includes a yoke sensor arm 310, which has as a set amount of rotational compliance relative to yoke 116. In particular embodiments, an isolator 312 is provided for enforcing the selected compliance in a rotational direction. Isolator 312 may be implemented using a torsion axle, rubber wedges/pads, or another material having the desired compliance in the rotational direction.

In particular embodiments, isolator 312 rotatably couples the yoke 116 to a central yoke support, or weldment, 314 that connects to lift system 122 (not shown in FIG. 3). As the surface the mower 100 is traversing changes, upward or downward rotation is fed to the isolator 312 via yoke 116. Isolator 312 reacts to this rotational motion by interacting with its housing comprising a portion of central yoke support 314.

A sensor 315, which in particular embodiments may comprise a potentiometer, may be rigidly mounted to yoke 116 and a connecting arm 316 is provided for connecting the sensor 315 to the yoke sensor arm 310 to enable sensor to detect a positive or negative deviation (or delta) of yoke 116 from a nominal position relative to cutting unit 114. In particular embodiments, the sensor 315 is rigidly mounted to the central yoke support/weldment and connected to the yoke 116 via the connecting arm 316 and the yoke sensor arm 310. The yoke sensor arm 310 is rigidly connected to the yoke 116.

The sensor 315 should be connected to a positive power supply and a negative (or ground). The sensor 315 should also include a feedback signal connection, or wire, if it is an analog sensor. If the sensor 315 is a CAN sensor, it should have power and related CANBus wires. Nominal power may be provided from the controller or vehicle electrical system. The feedback wire or CAN connection may feed into the actuator controller, which commands the actuator to extend or retract based on a delta (+or −) from the baseline/calibrated value as described hereinbelow.

The rate of change of the variation may also be detected and could be analyzed to check for an error, anomaly, or rapid obstacle that has passed before the feedback loop has properly reacted. The rate of change could also be used to calibrate the speed of the response function within the controller to not over-shoot the response. Over-shooting would result in an oscillation response like a bouncing ball without damping. It might be plausible to allow sensitivity to be an operator input based on their operating speeds.

The detected variation may be analyzed in either a closed loop feedback control system or via the CANBUS to cause the actuators to extend or retract to maintain the sensors in their nominal range for ground following. When a raise, store, or transport command is given, the feedback loop is ignored. It is activated in a MOW or similar mode in which the cutting units are expected to be on the ground/terrain.

At a vehicle architecture level, if CANBUS enabled, these outputs from the sensors could be combined with other onboard vehicle sensors to help build predictive adjustments or operator commands. Adjustments to sensitivity and feedback speed could be set based on speed or operator modes for the vehicle.

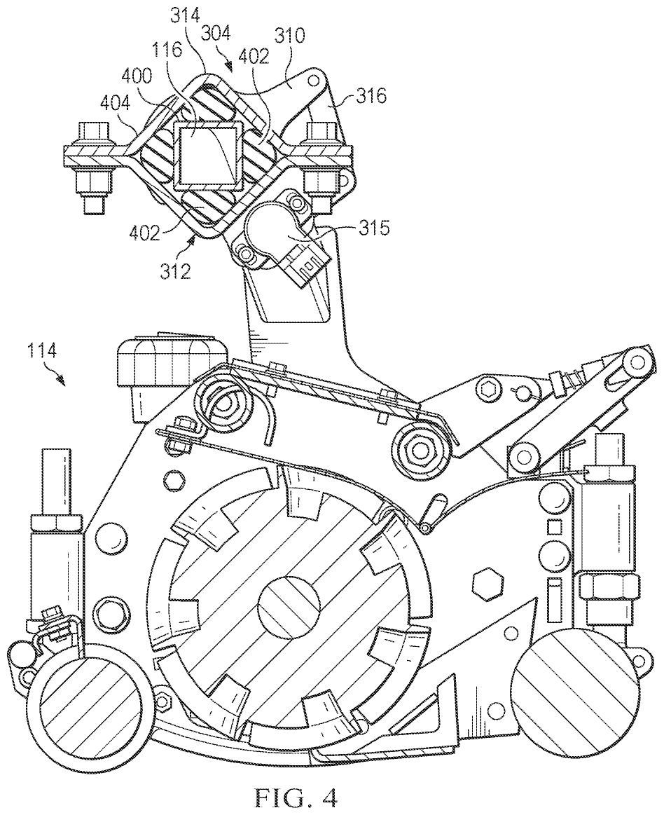

FIG. 4 is a side cutaway view of cutting unit 114 illustrating an embodiment of isolator in greater detail. As shown in FIG. 4, isolator 116 includes a torsion axle 400 having a square cross-section, four cords 402 comprising a flexible or pliant material, such as rubber, all arranged within a housing 404 that extends from yoke sensor arm 310 to a structure corresponding to arm 310 at the opposite end of mechanism 304. The length of the arm 310 may be based on how sensitively the sensor should react per its resolution. As shown in FIG. 4, arm 310 is fixed to shaft 400 and comprises an end stop to prevent the possibility of the shaft 400 sliding to one side instead of being centered about the isolator housing. As shown in FIG. 3, if the yoke 116 tried to translate laterally relative to isolator housing, arm 310 and corresponding structure on opposite end would operate to physically prevent that movement.

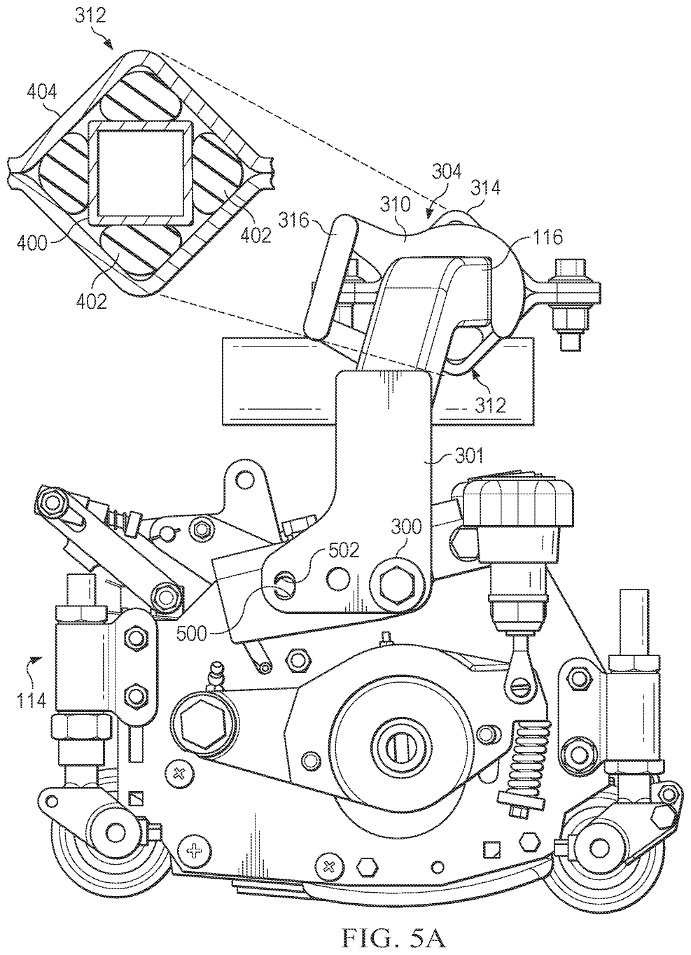

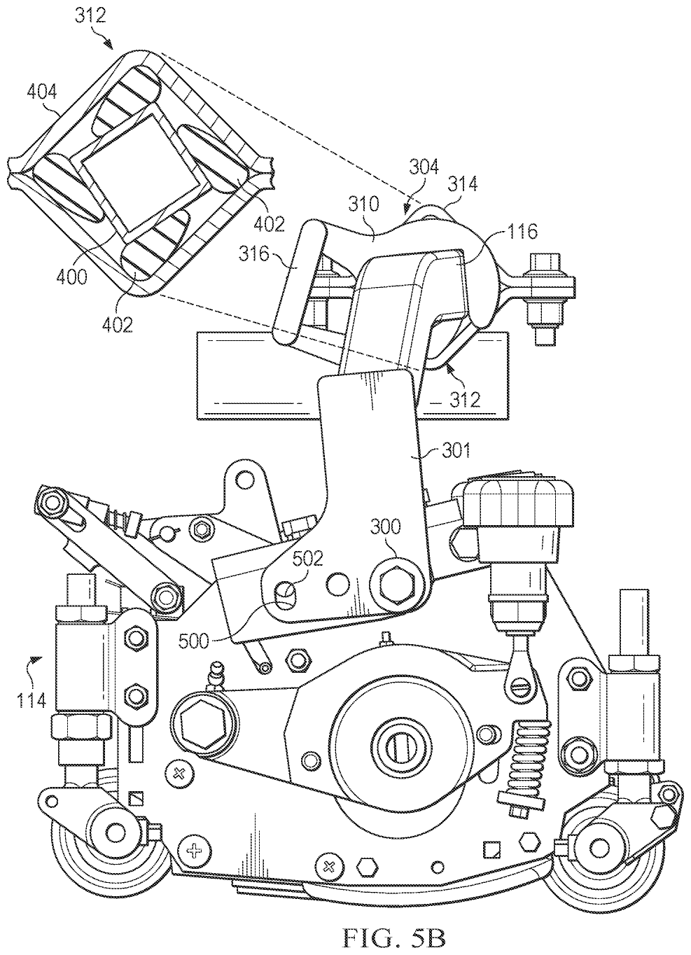

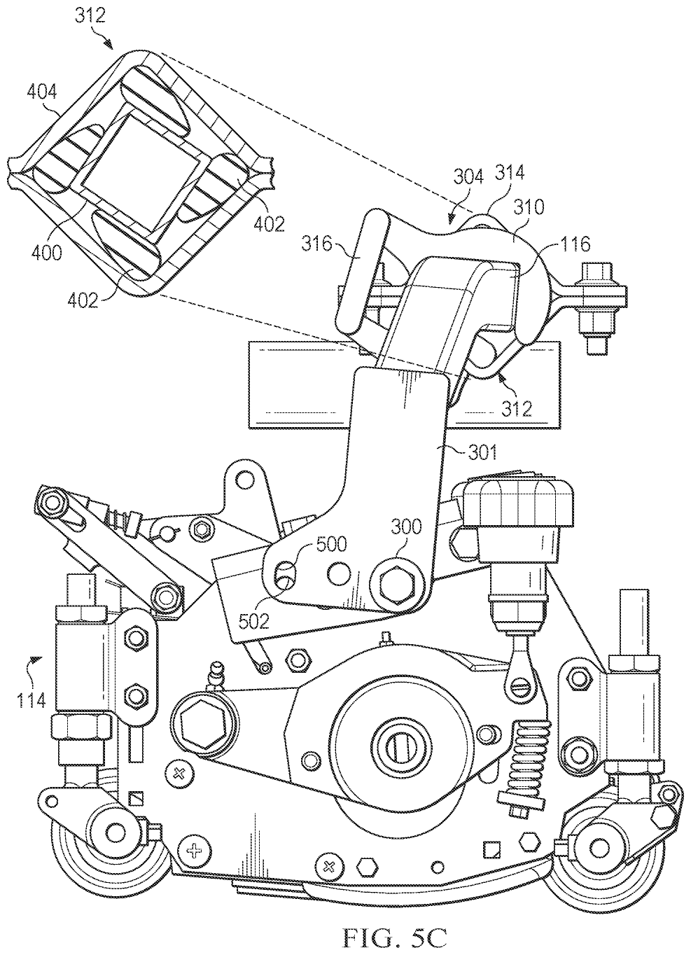

FIGS. 5A-5C illustrate side views of cutting unit 114/yoke 116, and particularly the connection therebetween, in which yoke 116 is in different states of rotation relative to cutting unit 114 and in different states of rotation relative to the central yoke support/weldment 314. These different states would indicate a command for up or down motion relative to nominal.

FIGS. 5A-5C further illustrate corresponding states of insulator 312 with regard to the rotational position of yoke 116 relative to cutting unit 114. As shown in FIGS. 5A-5C, each endplate 301 includes a slot 500 through which a corresponding protrusion 502 provided on ends of cutting unit 114 may be received. FIG. 5A illustrates yoke 116 in a nominal or neutral position relative to cutting unit 114. As further shown in FIG. 5A, axle 400 of insulator 312 is unrotated relative to housing 404 and cords 402 are undeformed.

FIG. 5B illustrates yoke 116 in a position in which yoke is rotated downward slightly relative to central yoke support 314. As further shown in FIG. 5B, axle 400 of insulator 312 has rotated slightly from neutral or nominal in a counter-clockwise direction, causing cords 402 to be deformed as shown. The downward movement or displacement of yoke 116 relative to cutting unit 114 is detected by sensor, which generates signals to be used in adjusting the position of the corresponding actuator to cause the yoke to return to the nominal position relative to cutting unit 114 (e.g., as illustrated in FIG. 5A). In particular, in the scenario illustrated in FIG. 5B, actuator will be commanded to extend a certain amount to return the yoke 116 to the nominal position. The weight of the unit is pulling the yoke 116 downward by gravity causing the distortion of the isolator as it rotated the yoke. Extending the actuator will return to nominal. In particular embodiments, if the actuator is at maximum extension, the command to lower may be ignored or an error could be displayed.

FIG. 5C illustrates yoke 116 in a position in which yoke is rotated upward slightly relative to central yoke support 314. As further shown in FIG. 5B, axle 400 of insulator 312 has rotated slightly from neutral or nominal in a clockwise direction, causing cords 402 to be deformed as shown. The upward movement or displacement of yoke 116 relative to cutting unit 114 is detected by sensor, which generates signals to be used in adjusting the position of the corresponding actuator to cause the yoke to return to the nominal position relative to cutting unit 114 (e.g., as illustrated in FIG. 5A). In particular, in the scenario illustrated in FIG. 5C, actuator will be commanded to retract a certain amount to return the yoke 116 to the nominal position.

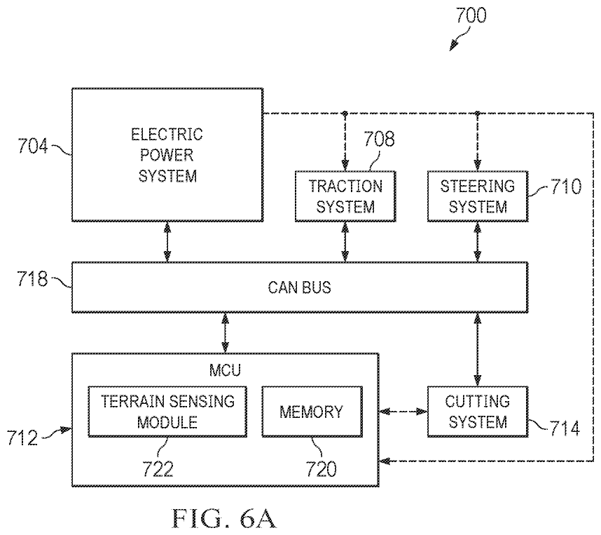

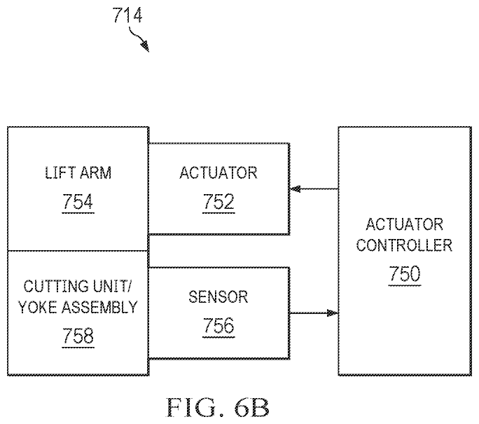

Referring now to FIG. 6A, illustrated therein is a block diagram of an example control system 700 for a lawn mower, such as mower 100 (FIGS. 1A-1E). It will be recognized that in FIG. 6A dashed arrows represent power flow, whereas solid arrows represent communications flow. In accordance with features of embodiments described herein, upon ignition or power on condition of a mower, assuming specified safety considerations are satisfied, an electric power system 702 may distribute power from a power source, such as a lithium battery pack (LBP) (which in some embodiments may be a 48 volt DC LPB) to one or more of a traction system 708, a steering system 710, a master control unit (MCU) 712, and a cutting system 714, all of which may be interconnected via a CANBUS 718. MCU 712 may include one or more memory devices 720 for storing data for use in operation of the mower and a terrain sensing module 722.

Traction system 708 may control rotational speed of individual wheels of the vehicle in response to command speeds received from MCU 712. Steering system 710 may receive inputs from a steering wheel to control the steered angle of one or more of the wheels. Steering system 710 may further report the steered angle of each of the wheels to MCU 712 via CAN bus 818. In operation, MCU 712 may control speed, acceleration, deceleration, and current limit of traction motors comprising traction system 708 by sending appropriate signals to traction system to via CAN bus 718. Traction motors comprising traction system 708 may report back to MCU 712 via CAN bus 718 a variety of parameters, such as actual traction motor speed, actual traction motor current, traction control unit temperature, and error state, for example.

In various embodiments, control system 700 may include more, fewer, or other components than shown in FIG. 6A. For example, control system 700 may further include additional processors, input/output (I/O) devices, communications links, and memory. Control system 700 may be operable to perform one or more operations of various embodiments as described herein. Although the embodiment shown provides one example of control system 700 that may be used with other embodiments, such other embodiments may utilize control systems other than control system 700. Additionally, embodiments may also employ multiple control systems, such as control system 700. Control system 700 may exist wholly or partially on-board the mower, off-board the mower (e.g., in a ground station), or a combination of the two.

MCU 712 may be implemented as a processor or other device operable to execute logic contained within a medium. Examples of such devices include one or more microprocessors, one or more applications, and/or other logic. Control system 700 may include one or multiple such devices. Control system 700 may include input/output devices including any device or interface operable to enable communication between control system 700 and external components, including communication with an operator or another system. Example input/output devices may include, but are not limited to, a mouse, keyboard, display, and printer.

Network interfaces may be provided to facilitate communication between control system 700 and another element of a network, such as other computer systems. Network interfaces may connect to any number and combination of wireline and/or wireless networks suitable for data transmission, including transmission of communications. Network interfaces may, for example, communicate audio and/or video signals, messages, internet protocol packets, frame relay frames, asynchronous transfer mode cells, and/or other suitable data between network addresses. Network interfaces connect to a computer network or a variety of other communicative platforms including, but not limited to, a public switched telephone network (PSTN); a public or private data network; one or more intranets; a local area network (LAN); a metropolitan area network (MAN); a wide area network (WAN); a wireline or wireless network; a local, regional, or global communication network; an optical network; a satellite network; a cellular network; an enterprise intranet; all or a portion of the Internet; other suitable network interfaces; or any combination of the preceding.

Control system 700 may include additional memory devices comprising any suitable storage mechanism which may store any data for use by control system 700. Memory may comprise one or more tangible, computer readable, and/or computer-executable storage medium. Examples of memory include computer memory (for example, Random Access Memory (RAM) or Read Only Memory (ROM)), mass storage media (for example, a hard disk), removable storage media (for example, a Compact Disk (CD) or a Digital Video Disk (DVD)), database and/or network storage (for example, a server), and/or other computer-readable medium.

In some embodiments, memory stores logic for facilitating operation of control system 700. Logic may include hardware, software, and/or other logic and may be encoded in one or more tangible, non-transitory media and may perform operations when executed by a computer. Logic may include a computer program, software, computer executable instructions, and/or instructions capable of being executed by control system 700. Example logic may include any of the well-known OS2, UNIX, Mac-OS, Linux, and Windows Operating Systems or other operating systems. In particular embodiments, the operations of the embodiments may be performed by one or more computer readable media storing, embodied with, and/or encoded with a computer program and/or having a stored and/or an encoded computer program. Logic may also be embedded within any other suitable medium without departing from the scope of the invention.

FIG. 6B illustrates a simplified block diagram of cutting system 714 in accordance with features of embodiments described herein. As shown in FIG. 6B, cutting system 714 includes an actuator controller 750 for controlling operation of a lift actuator 752 for lifting and lowering lift arm 754 under the control of signals from controller 750 generated in response to sensor signals from sensor 756 associated with cutting unit/yoke assembly 758. Although as shown in FIG. 6B, cutting system 714 is shown as comprising single ones of actuator controller 750, lift actuator 752, lift arm 754, sensor 756, and cutting unit/yoke assembly 758, cutting system may include more than one of each such element as necessary or desirable for accomplishing one or more particular purposes.

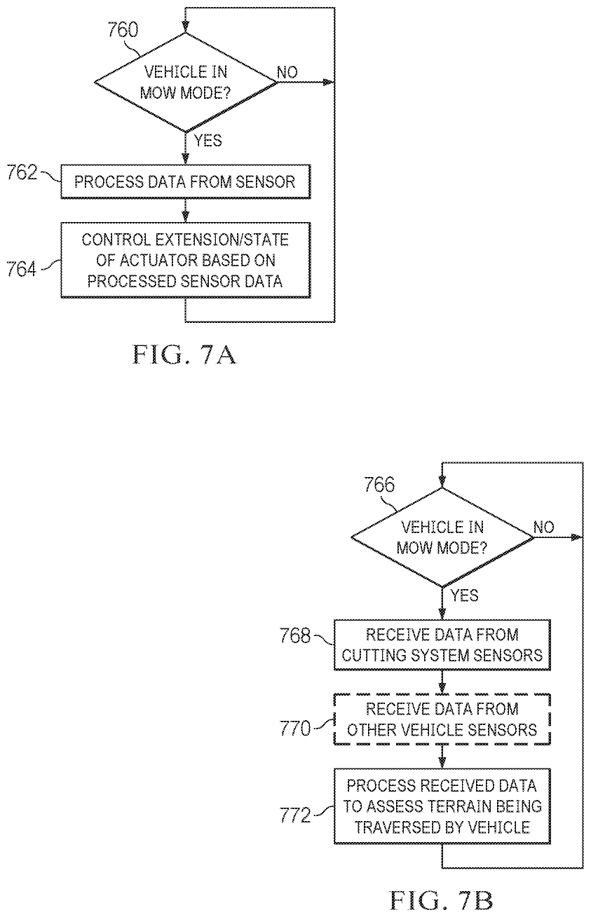

FIG. 7A illustrates a flowchart illustrating example operations for enabling sensitive float features of embodiments described herein. In certain embodiments, one or more of the operations illustrated in FIG. 7A may be executed by one or more of the elements shown in FIG. 6A or 6B, such as MCU 712 and/or actuator controller 750, for example.

Referring to FIG. 7A, in 760, a determination is made whether the vehicle is in a MOW (or equivalent) mode. If not, execution remains at 760 until it a determination is made that the vehicle is in MOW (or equivalent) mode.

Once it is determined in step 760 that the vehicle is in MOW (or equivalent) mode, execution proceeds to 762. In 762, data received from the sensor, such as sensor 315, is processed. In particular, the sensor data is processed to determine a deviation or displacement of the position of the yoke relative to the cutting unit from a nominal position. It will be recognized that the displacement may be positive (e.g., in an upward direction from nominal or neutral) or negative (e.g., in a downward direction from nominal or neutral).

In 764, the extension or state of the lift actuator may be adjusted based on the sensor data. For example, if the sensor data indicates a positive deviation from the nominal position, control signals may be issued to the actuator to cause the actuator to retract a designated amount designed to allow the yoke, and the sensor, to return to nominal. In contrast, if the sensor data indicates a negative deviation from the nominal position, control signals may be issued to the actuator to cause the actuator to extend a designated amount designed to allow the yoke, and the sensor, to return to nominal. If the sensor data indicates that the yoke is in the nominal position, no change will be made to the position of the actuator. The amount of the extension or retraction (or the additional extension or retraction) of the actuator may be based on the absolute value of the deviation or displacement; that is, the greater the deviation, the greater the adjustment to the actuator position that will be required.

Execution then returns to 760.

It will be recognized that the operations illustrated in FIG. 7A (or variations thereof) may be executed in such a manner as to periodically calibrate the system to establish the nominal position of the yoke relative to the cutting unit and the corresponding nominal sensor signal. This feature may be useful in situations in which accessories, such as brushes, are attached to and/or removed from cutting units, for example, thereby affecting the balance and center of gravity of the corresponding cutting unit/yoke assembly. In particular implementations, the mower could be operated on a known flat surface, with the resulting sensor signal being set as the nominal signal value. It will be further recognized that one or more such nominal signal values may be stored in persistent memory of MCU 712 (FIG. 6A). In particular embodiments, multiple nominal signal values may be stored in persistent memory and associated with different cutting unit configurations. It will be noted that a special mower operational mode (e.g., a CALLIBRATION mode) may be provided for such purposes.

Although the operations of the example method shown in and described with reference to FIG. 7A are illustrated as occurring once each and in a particular order, it will be recognized that the operations may be performed in any suitable order and repeated as desired. Additionally, one or more operations may be performed in parallel. Furthermore, the operations illustrated in FIG. 7A may be combined or may include more or fewer details than described.

FIG. 7B illustrates a flowchart illustrating example operations for enabling features of embodiments described herein. In certain embodiments, one or more of the operations illustrated in FIG. 7B may be executed by one or more of the elements shown in FIG. 6A or 6B, such as MCU 712 and/or actuator controller 750, for example. In particular embodiments, one or more operations illustrated in FIG. 7B may be performed by terrain sensing module 722 (FIG. 7A).

Referring to FIG. 7B, in 766, a determination is made whether the vehicle is in a MOW (or equivalent) mode. If not, execution remains at 766 until it a determination is made that the vehicle is in MOW (or equivalent) mode.

Once it is determined in step 766 that the vehicle is in MOW (or equivalent) mode, execution proceeds to 768. In 768, data is received from each of multiple cutting unit sensors, such as sensors 315.

In optional 770, sensor data may be received from other sensors installed on the vehicle. Such sensors may include LIDAR sensors and/or cameras for capturing image data of the environment of the vehicle.

In 772, the received sensor data may be processed to assess the terrain being traversed by the vehicle. In particular, the cutting unit/yoke assembly sensor data may be processed to determine a deviation of the position of each yoke relative to the respective cutting unit from the nominal position. The data may further be processed to determine the terrain of the current location of the vehicle based on the relative positions of the yoke/cutting unit assemblies. This information may be supplemented by sensor data from the onboard image sensors and/or used to create a terrain map of a designated area. Such a terrain map may be stored for subsequent use by the vehicle and/or other vehicles. Additionally and/or alternatively, the terrain map may be used to predict extension/retraction of actuators in view of terrain to be encountered.

Execution then returns to 766.

Although the operations of the example method shown in and described with reference to FIG. 7B are illustrated as occurring once each and in a particular order, it will be recognized that the operations may be performed in any suitable order and repeated as desired. Additionally, one or more operations may be performed in parallel. Furthermore, the operations illustrated in FIG. 7B may be combined or may include more or fewer details than described.

Example 1 provides a control system for a vehicle cutting system, the vehicle cutting system including a cutting unit connected to a lift arm of a lift system via a yoke, the lift system including a lift actuator for lifting and lowering the lift arm, the cutting unit and the yoke, the control system including a sensor for sensing a displacement of the yoke from a nominal position relative to the cutting unit and for generating a displacement signal indicative of the sensed displacement; and a controller for processing the displacement signal and adjusting a position of the lift actuator based on the processing.

Example 2 provides the control system of example 1, wherein the cutting unit is rotatably connected to the yoke and the displacement of the yoke includes a rotational displacement of the yoke relative to a central support of the yoke.

Example 3 provides the control system of example 2, wherein a maximum amount of the rotational displacement of the yoke relative to the central support of the yoke is limited by an isolator.

Example 4 provides the control system of any of examples 1-3, wherein the sensor includes a potentiometer.

Example 5 provides the control system of any of examples 1-4, wherein the sensor includes a strain gauge.

Example 6 provides the control system of any of examples 1-5, wherein when the sensed displacement is in an upward direction, the controller causes the lift actuator to retract a designated amount.

Example 7 provides the control system of example 6, wherein the designated amount is dependent upon an amount of the sensed displacement.

Example 8 provides the control system of any of examples 1-7, wherein when the sensed displacement is in a downward direction, the controller causes the lift actuator to extend a designated amount.

Example 9 provides the control system of example 8, wherein the designated amount is dependent upon an amount of the sensed displacement.

Example 10 provides a method of controlling a cutting system of a mower, the cutting system including a cutting unit connected to a lift arm of a lift system via a yoke, the lift system including a lift actuator for lifting and lowering the lift arm, the cutting unit and the yoke, the method including sensing a displacement of the yoke from a nominal position relative to a central support of the yoke; and adjusting an amount of extension of the lift actuator based on the sensed displacement, wherein the cutting unit is rotatably connected to the yoke and the displacement of the yoke includes a rotational displacement of the yoke relative to a central support of the yoke.

Example 11 provides the method of example 10, wherein when the sensed displacement is in an upward direction and wherein the adjusting includes reducing the amount of extension of the lift actuator a designated amount, wherein the designated amount is dependent upon an amount of the sensed displacement.

Example 12 provides the method of any of examples 10-11, wherein when the sensed displacement is in a downward direction and wherein the adjusting includes increasing the amount of extension of the lift actuator a designated amount, wherein the designated amount is dependent upon an amount of the sensed displacement.

Example 13 provides the method of any of examples 10-12, further including processing the sensed displacement to determine a terrain being traversed by the mower.

Example 14 provides the method of example 13, wherein the processing the sensed displacement further includes processing data from an image sensor installed on the mower along with the sensed displacement to determine the terrain being traversed by the mower.

Example 15 provides the method of example 14, wherein the data includes at least one of camera data and light detection and ranging (LIDAR) sensor data.

Example 16 provides the method of any of examples 13-15, further including generating a terrain map based on the processing.

Example 17 provides a mower including a lift system including at least one lift arm; at least one cutting unit attached to the at least one cutting unit via a yoke rotatably attached to the cutting unit; at least one lift actuator associated with the at least one lift arm; at least one sensor associated with the at least one cutting unit for detecting a rotational displacement of the yoke relative to a central support of the yoke and generating a signal indicative of the detected rotational displacement; and at least one controller for processing the signal indicative of the detected rotational displacement and generating a command signal to the at least one lift actuator to cause the at least one lift actuator to adjust an extension thereof based on the signal.

Example 18 provides the mower of example 17, further including at least one image sensor for generating image data of an environment of the mower, wherein the at least one controller receives the image data and processes the image data and the received signal to determine a terrain being traversed by the mower.

Example 19 provides the mower of any of examples 17-18, wherein when the detected rotational displacement is in an upward direction and wherein the adjusting includes reducing the amount of extension of the at least one lift actuator a designated amount, wherein the designated amount is dependent upon an amount of the detected rotational displacement.

Example 20 provides the mower of any of examples 17-19, wherein when the detected rotational displacement is in a downward direction and wherein the adjusting includes increasing the amount of extension of the lift actuator a designated amount, wherein the designated amount is dependent upon an amount of the detected rotational displacement.

At least one representative embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru-RI), wherein k is a variable ranging from 1 percent to 100 percent with a 1 percent increment, i.e., k is 1 percent, 2 percent, 3 percent, 4 percent, 5 percent . . . 50 percent, 51 percent, 52 percent . . . , 95 percent, 96 percent, 95 percent, 98 percent, 99 percent, or 100 percent. Moreover, any numerical range defined by two R numbers as defined in the above is also specifically disclosed.

Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C. The terms “substantially,” “close,” “approximately,” “near,” and “about,” generally refer to being within +/−5-20% of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the context of a particular value as described herein or as known in the art.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A control system for a vehicle cutting system, the vehicle cutting system comprising a cutting unit connected to a lift arm of a lift system via a yoke, the lift system comprising a lift actuator for lifting and lowering the lift arm, the cutting unit and the yoke, the control system comprising:
a sensor for sensing a displacement of the yoke from a nominal position relative to the cutting unit and for generating a displacement signal indicative of the sensed displacement; and
a controller for processing the displacement signal and adjusting a position of the lift actuator based on the processing.

2. The control system of claim 1, wherein the cutting unit is rotatably connected to the yoke and the displacement of the yoke comprises a rotational displacement of the yoke relative to a central support of the yoke.

3. The control system of claim 2, wherein a maximum amount of the rotational displacement of the yoke relative to the central support of the yoke is limited by an isolator.

4. The control system of claim 1, wherein the sensor comprises a potentiometer.

5. The control system of claim 1, wherein the sensor comprises a strain gauge.

6. The control system of claim 1, wherein when the sensed displacement is in an upward direction, the controller causes the lift actuator to retract a designated amount.

7. The control system of claim 6, wherein the designated amount is dependent upon an amount of the sensed displacement.

8. The control system of claim 1, wherein when the sensed displacement is in a downward direction, the controller causes the lift actuator to extend a designated amount.

9. The control system of claim 8, wherein the designated amount is dependent upon an amount of the sensed displacement.

10. A method of controlling a cutting system of a mower, the cutting system comprising a cutting unit connected to a lift arm of a lift system via a yoke, the lift system comprising a lift actuator for lifting and lowering the lift arm, the cutting unit and the yoke, the method comprising:
sensing a displacement of the yoke from a nominal position relative to a central support of the yoke; and
adjusting an amount of extension of the lift actuator based on the sensed displacement,
wherein the cutting unit is rotatably connected to the yoke and the displacement of the yoke comprises a rotational displacement of the yoke relative to a central support of the yoke.

11. The method of claim 10, wherein when the sensed displacement is in an upward direction and wherein the adjusting comprises reducing the amount of extension of the lift actuator a designated amount, wherein the designated amount is dependent upon an amount of the sensed displacement.

12. The method of claim 10, wherein when the sensed displacement is in a downward direction and wherein the adjusting comprises increasing the amount of extension of the lift actuator a designated amount, wherein the designated amount is dependent upon an amount of the sensed displacement.

13. The method of claim 10, further comprising processing the sensed displacement to determine a terrain being traversed by the mower.

14. The method of claim 13, wherein the processing the sensed displacement further comprises processing data from an image sensor installed on the mower along with the sensed displacement to determine the terrain being traversed by the mower.

15. The method of claim 14, wherein the data comprises at least one of camera data and light detection and ranging (LIDAR) sensor data.

16. The method of claim 13, further comprising generating a terrain map based on the processing.

17. A mower comprising:
a lift system comprising at least one lift arm;
at least one cutting unit attached to the at least one cutting unit via a yoke rotatably attached to the cutting unit;
at least one lift actuator associated with the at least one lift arm;
at least one sensor associated with the at least one cutting unit for detecting a rotational displacement of the yoke relative to a central support of the yoke and generating a signal indicative of the detected rotational displacement; and
at least one controller for processing the signal indicative of the detected rotational displacement and generating a command signal to the at least one lift actuator to cause the at least one lift actuator to adjust an extension thereof based on the signal.

18. The mower of claim 17, further comprising at least one image sensor for generating image data of an environment of the mower, wherein the at least one controller receives the image data and processes the image data and the received signal to determine a terrain being traversed by the mower.

19. The mower of claim 17, wherein when the detected rotational displacement is in an upward direction and wherein the adjusting comprises reducing the amount of extension of the at least one lift actuator a designated amount, wherein the designated amount is dependent upon an amount of the detected rotational displacement.

20. The mower of claim 17, wherein when the detected rotational displacement is in a downward direction and wherein the adjusting comprises increasing the amount of extension of the lift actuator a designated amount, wherein the designated amount is dependent upon an amount of the detected rotational displacement.
